(19) United States
(12) Patent Application Publication
(10) Pub. No.: US 2026/0281689 A1
(43) Pub. Date: Sep. 17, 2026

(54) INTERNET OF THINGS TERMINAL MANAGEMENT METHOD AND RELEVANT APPARATUS

(71) Applicant: TENCENT TECHNOLOGY (SHENZHEN) COMPANY LIMITED, Shenzhen (CN)

(72) Inventor: Yixue LEI, Shenzhen (CN)

(21) Appl. No.: 19/673,426

(22) Filed: May 11, 2026

Related U.S. Application Data
(63) Continuation of application No. PCT/CN2024/133614, filed on Nov. 21, 2024.

(30) Foreign Application Priority Data
Dec. 28, 2023 (CN) 202311861703.9

(51) Int. Cl. H04W 8/08

(52) U.S. Cl. CPC H04W 8/08

(57) ABSTRACT

A management method, a management device, and a non-transitory computer-readable storage medium. The management method is applied to a core network element of a mobile network and includes obtaining device information of an Internet of Things (IoT) terminal, and performing management on the IoT terminal according to the device information. The management includes at least one of access management or mobility management.

### CROSS-REFERENCE TO RELATED APPLICATIONS

This application is a continuation of International Application No. PCT/CN2024/133614, filed on November 21, 2024, which claims priority to Chinese Patent Application No. 202311861703.9, filed with the China National Intellectual Property Administration on Dec. 28, 2023 and entitled “INTERNET OF THINGS TERMINAL MANAGEMENT METHOD AND RELEVANT APPARATUS,” the entire contents of both of which are incorporated herein by reference.

### FIELD OF THE TECHNOLOGY

This application relates to the field of communication technologies, and specifically to an IoT terminal management method and a relevant apparatus.

### BACKGROUND OF THE DISCLOSURE

ambient Internet of Things (IoT) is a passive wireless communication technology with low power consumption and self-powered by wireless electricity, configured for communication between an IoT device and a sensor. The ambient IoT uses energy (such as light energy, heat energy, and vibration energy) in an environment for power supply. Therefore, a battery or a cable connection is not needed, and the ambient IoT has advantages such as easy installation and low maintenance costs. The ambient IoT technology is applicable to various scenarios, such as a smart building, a smart home, and industrial automation, and may be configured for implementing functions such as automation control, monitoring, and data collection.

In current mobile communication technology, the end-to-end network architecture and protocol design are implemented based on a terminal needing a battery or a cable connection, which does not support the ambient IoT technology. Therefore, how to support the ambient IoT technology in a mobile communication network is a problem that needs to be continuously researched and resolved by a person skilled in the art.

### SUMMARY

In accordance with the disclosure, there is provided a management method applied to a core network element of a mobile network and including obtaining device information of an Internet of Things (IoT) terminal, and performing management on the IoT terminal according to the device information. The management includes at least one of access management or mobility management.

Also in accordance with the disclosure, there is provided a management device including one or more processors, and a memory storing one or more programs that, when executed by the one or more processors, cause the management device to obtain device information of an Internet of Things (IoT) terminal, and perform management on the IoT terminal according to the device information. The management includes at least one of access management or mobility management.

Also in accordance with the disclosure, there is provided a management method applied to an access network element or a non-access network element of a mobile network and including establishing a communication connection to an IoT terminal, establishing a communication connection to a core network of the mobile network, and performing management on the IoT terminal based on signaling interaction with the core network. The management includes at least one of access management or mobility management.

### BRIEF DESCRIPTION OF THE DRAWINGS

FIG. 1 is a schematic architectural diagram of an exemplary Internet of Things (IoT) terminal management system.

FIG. 2 is a flowchart of an IoT terminal management method according to an exemplary embodiment of this application.

FIG. 3 is a flowchart of an IoT terminal management method according to another exemplary embodiment of this application.

FIG. 4 is a flowchart of an IoT terminal management method according to still another exemplary embodiment of this application.

FIG. 5 is a flowchart of an IoT terminal management method according to still another exemplary embodiment of this application.

FIG. 6A is a schematic diagram showing transition among different substates of an IoT terminal.

FIG. 6B is a schematic overall state transition diagram formed based on a substate transition process in FIG. 6A.

FIG. 7 is a flowchart of an IoT terminal management method according to another exemplary embodiment of this application.

FIG. 8 is a block diagram of an IoT terminal management apparatus according to an exemplary embodiment of this application.

FIG. 9 is a block diagram of an IoT terminal management apparatus according to another exemplary embodiment of this application.

FIG. 10 is a schematic structural diagram of a computer system suitable for implementing an IoT terminal management device according to an embodiment of this application.

### DESCRIPTION OF EMBODIMENTS

Exemplary embodiments are described in detail herein, and examples of the exemplary embodiments are shown in the accompanying drawings. When the following descriptions are made with reference to the accompanying drawings, unless indicated otherwise, the same numbers in different accompanying drawings represent the same or similar elements. The implementations described in the following exemplary embodiments do not represent all implementations consistent with this application. On the contrary, the implementations are merely examples of apparatuses and methods that are described in detail in the appended claims and that are consistent with some aspects of this application.

The block diagrams shown in the accompanying drawings are merely functional entities and do not necessarily correspond to physically independent entities. In other words, these functional entities may be implemented in a form of software, or implemented in one or more hardware modules or integrated circuits, or implemented in different networks and/or processor apparatuses and/or microcontroller apparatuses.

The flowcharts shown in the accompanying drawings are merely exemplary descriptions, do not necessarily include all content and operations/steps, and do not necessarily need to be performed in a described sequence. For example, some operations/steps may further be decomposed, and some operations/steps may be combined or partially combined. Therefore, an actual execution sequence may be changed according to an actual situation.

A term “multiple” in this application means two or more. A term “and/or” describes an association relationship for describing associated objects and represents that three relationships may exist. For example, A and/or B may represent the following three cases: Only A exists, both A and B exist, and only B exists. A character “/” generally indicates an “or” relationship between the associated objects.

In the specification, the claims, and the accompanying drawings of this application, terms “first,” “second,” “third,” “fourth,” and the like are intended to distinguish between different objects rather than describe a particular sequence. Terms “include,” “comprise,” “have” and any variants thereof are intended to cover a non-exclusive inclusion. For example, a process, a method, a system, a product, or a device including a series of operations or units is not limited to listed operations or units, but in some embodiments, further includes an operation or a unit that is not listed, or further exemplarily includes another operation or unit inherent to the process, the method, the product, or the device.

As described above, an ambient Internet of Things (IoT) technology has advantages such as low power consumption, self-powering via wireless electricity, easy mounting, and low maintenance costs. However, because a current mobile communication technology is implemented on an end-to-end network architecture and protocol design based on a terminal needing a battery supply or a cable connection, the ambient IoT technology is not supported.

Compared with the terminal needing the battery supply or the cable connection, an IoT terminal in ambient IoT may encounter some special situations during application. For example, the IoT terminal may be discontinuously powered down. For example, when a battery level is insufficient or there is no battery, because the terminal needs to work with the help of solar energy, the terminal can work only during the daytime, and is powered down at night. For another example, to save energy, the IoT terminal may disable a transmitter (TX) or a receiver (RX) by default. Consequently, a core network side cannot obtain a status of the IoT terminal in real time to perform connectivity management.

To deal with these special situations of the IoT terminal in the ambient IoT, this application provides an IoT terminal management system.

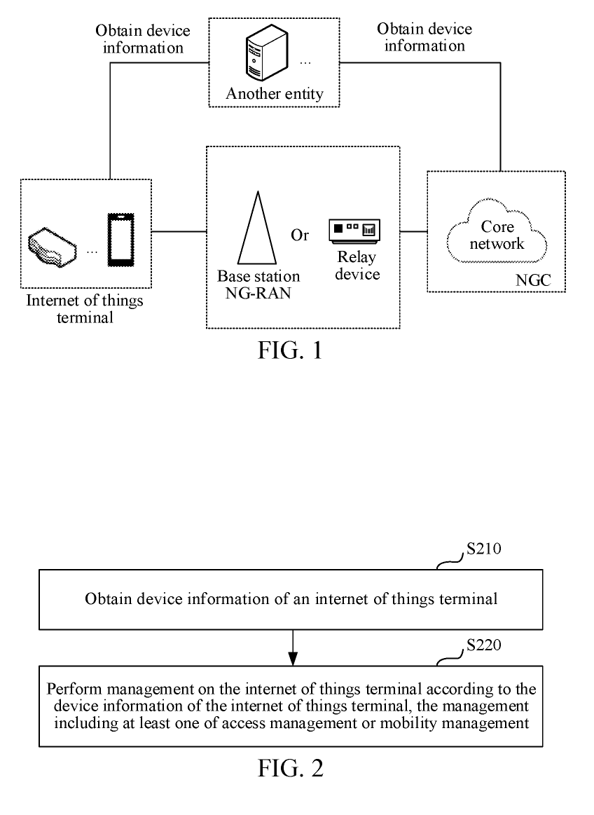

FIG. 1 is an exemplary schematic architectural diagram of an IoT terminal management system. An IoT terminal is connected to a core network via a base station or a relay device. Therefore, management may be performed on the IoT terminal based on signaling interaction between the base station or the relay device and the core network. Device information of the IoT terminal required when the core network performs the management on the IoT terminal may be directly obtained from the IoT terminal, or may be obtained from another entity having the device information of the IoT terminal.

The IoT terminal shown in FIG. 1 may include an IoT terminal in ambient IoT, or may include an IoT terminal in another IoT environment. This is not limited in this application.

Based on the system architecture shown in FIG. 1, this application further correspondingly provides an IoT terminal management solution supported in a mobile network. The following describes the IoT terminal management solution provided in this application.

In an exemplary embodiment, the mobile network needs to obtain the device information of the IoT terminal, to provide access management and mobility management on the IoT terminal according to the device information of the IoT terminal.

Exemplarily, a manner in which the mobile network obtains the device information of the IoT terminal includes a direct obtaining manner or an indirect obtaining manner. The direct obtaining manner means that the IoT terminal or the another entity having the device information of the IoT terminal transmits the device information of the IoT terminal to the mobile network. The another entity is, for example, a device like a server or an assisting node. The indirect obtaining manner means that after recognizing a communication connection to the IoT terminal, the mobile network obtains the device information of the IoT terminal from a specific entity by using identifier information obtained by recognizing the IoT terminal. The specific entity may be the same as the foregoing another entity, or may be a device different from the another entity. For example, the specific entity may alternatively be a specific core network element. This is not limited in this application.

Regardless of the direct obtaining manner or the indirect obtaining manner, a security mechanism may be introduced between a party that obtains information and a party whose information is obtained. For example, the party that obtains information and the party whose information is obtained may be authenticated by using a pre-configured root key and a preset security authentication algorithm in a subscriber identity module (SIM) card, or may be authenticated in a non-SIM manner, for example, by using a digital certificate. This is not limited in this application.

The device information of the IoT terminal may include one or more of position information, application scenario information, type information, or another information.

The position information of the IoT terminal may include a specific position of the IoT terminal, or may include type information corresponding to the position of the IoT terminal, for example, an outdoor position or an indoor position. This application does not limit content of the position information. Exemplarily, the mobile network may set a management policy for the IoT terminal according to the position information of the IoT terminal. For example, mobility of an IoT terminal in an indoor environment is relatively weak. Therefore, a relevant management policy may be set according to this characteristic. This application does not limit the management policy set by the mobile network according to the position information of the IoT terminal.

The application scenario information of the IoT terminal is configured for describing an application scenario of the IoT terminal, and the application scenario may be, for example, a scenario of a factory, a school, a road, a bridge, energy, or livestock and husbandry. This application does not limit content of the application scenario either. Similarly, the mobile network may set the management policy for the IoT terminal according to the application scenario information of the IoT terminal. For example, the IoT terminal mounted in a bridge is usually stationary, so that mobility management may not be performed on the IoT terminal. Similarly, this application still does not limit the management policy set by the mobile network according to the application scenario information of the IoT terminal.

The type information of the IoT terminal may include one or more of information configured for describing an energy characteristic of the IoT terminal and information configured for describing a communication connection type of the IoT terminal. This application does not limit the type information.

The communication connection type of the IoT terminal may include an active connection type or a passive connection type. For example, under the active connection type, the IoT terminal first establishes a connection to the mobile network, and then may deactivate the connection. Subsequently, the IoT terminal may be connected to the mobile network again in preset time and maintain the connection when capable. Under the passive connection type, the IoT terminal is not actively connected to the mobile network, and establishes the connection for data transmission only after being triggered by the mobile network or another device. Therefore, the mobile network may perform network connection management on the IoT terminal according to the communication connection type of the IoT terminal. However, a specific management policy is not limited in this application.

The energy characteristic of the IoT terminal may include one or more of an energy storage characteristic, an energy harvesting capability, an energy consumption rate, or another information. This application does not limit specific content of the energy characteristic of the IoT terminal either.

The energy storage characteristic may include no energy storage capability or a specific energy storage capability. The specific energy storage capability may further include energy storage capability information, for example, a battery capacity.

The energy harvesting capability may include one or more of an energy harvesting means and energy harvesting efficiency of the IoT terminal. For example, the energy harvesting means of the IoT terminal may include one or more of the following means: solar energy, light energy, wind energy, electromagnetic energy, heat energy, or another means. For another example, the energy harvesting efficiency may include absolute efficiency or relative efficiency. The absolute efficiency may be energy collected per unit time, and the relative efficiency may be a percentage of the energy collected per unit time in the energy storage capability of the IoT terminal.

The energy consumption rate is configured for describing efficiency that the IoT terminal consumes energy due to communication, computation, or other processing, which may include, for example, one or more of an absolute value of energy consumed per unit time, and a percentage of the energy consumed per unit time in the energy storage capability of the IoT terminal; or may include an energy consumption rate that the IoT terminal performs consumption due to communication.

The mobile network may alternatively perform the network connection management on the IoT terminal according to the energy characteristic of the IoT terminal. For ease of understanding, for example, if the IoT terminal is powered through solar energy and does not have the energy storage capability, the mobile network can control data not to be transmitted to the IoT terminal at night. For another example, according to the battery capacity, the energy harvesting efficiency, and the energy consumption rate of the IoT terminal, the mobile network may predict that the IoT terminal cannot be powered at a future time point, so that corresponding data transmission control can be performed. This application does not limit specific content of the management on the IoT terminal performed by the mobile network according to the energy characteristic of the IoT terminal either.

In the technical solutions provided in this application, the mobile network may obtain the foregoing device information of the IoT terminal, to perform access or mobility management or the like on the IoT terminal, thereby supporting an ambient IoT technology in a mobile communication network.

The mobile network disclosed in this application may be a 5th generation mobile communication technology (5G) network or a 6th generation mobile communication technology (6G) network, but is not limited thereto.

An embodiment of this application further provides other IoT terminal management solutions. For example, in an exemplary embodiment, a mobile network further provides access management on the IoT terminal. The access management by the mobile network on the IoT terminal may include two parts: wireless side access management and core network side access management.

The wireless side access management is to directly establish a connection between the IoT terminal and a network device responsible for a wireless access terminal in the mobile network. The network device responsible for the wireless access terminal in the mobile network may be an access network element, for example, the base station, or may be a non-access network element, for example, a relay device or another device. This is not limited in this application.

A wireless side access management manner may be determined according to the communication connection type included in the device information of the IoT terminal. For example, if the communication connection type of the IoT terminal is the active connection type, a communication connection is established between the IoT terminal and the network device responsible for the wireless access terminal in a manner in which the IoT terminal initiates the connection. If the communication connection type of the IoT terminal is the passive connection type, the communication connection between the IoT terminal and the network device responsible for the wireless access terminal is established in a manner in which the network device initiates the connection.

In a mode in which the IoT terminal initiates the connection, the IoT terminal may actively initiate a communication connection request to the network device responsible for the wireless access terminal in the mobile network when energy of the IoT terminal and a data communication requirement of the IoT terminal exist. The communication connection request may carry usage information for a target network resource, where the target network resource may be a shared network resource, or may be a dedicated network resource. A using manner of the shared network resource may be contention-based random access, and a random access response window may be increased. In this way, a probability of direct collision between different terminals may be reduced in a high-density scenario. The dedicated network resource may be, for example, a dedicated passive IoT frequency band or a wireless resource. When the dedicated network resource is the wireless resource, the dedicated network resource may be specifically a specific random access codeword resource reserved for the passive IoT, to satisfy a characteristic of dense deployment of the IoT terminal.

In a mode in which the network device responsible for the wireless access terminal initiates the connection, the network device may wake up a specific IoT terminal in a manner like broadcast, unicast, or multicast. In addition, for ease of management, different IoT terminals may be divided into different groups according to application scenarios or other criteria. For example, IoT terminals in the same application scenario are grouped into the same group, and wake-up of the IoT terminals is performed by using a group as a wake-up unit. In this way, when different IoT terminals are woken up, impact on all IoT terminals can be avoided. Different IoT terminals may alternatively use a specific wake-up information sequence according to the group, and the sequence may be used as a part of identification information for recognizing the IoT terminals. In this way, multiple IoT terminals in the same group may be sequentially woken up.

The core network side access management is responsible for cooperating with a wireless side to complete end-to-end access, including performing authentication in a wireless side connection process and establishing connections to various protocol layers. These protocol layers are, for example, protocols similar to an access stratum (AS) or a non-access stratum (NAS), and may be divided into user plane protocols and control plane protocols. This application does not limit content and a naming manner of relevant protocol layers. If the core network side needs to establish a protocol data unit (PDU) session, an Internet protocol (IP) connection may be established after the PDU session is established.

In another embodiment, the mobile network further provides the mobility management on the IoT terminal. Exemplarily, the mobile network first needs to recognize a mobility type of the IoT terminal, to provide the mobility management on the IoT terminal based on the mobility type of the IoT terminal. The mobility type of the IoT terminal may include a stationary type, a first mobile type, or a second mobile type. The first mobile type and the second mobile type in this application are both relative concepts. However, a terminal movement speed corresponding to the first mobile type is to be lower than a terminal movement speed corresponding to the second mobile type. A specific condition for dividing the two types is not limited in this application.

The mobile network provides the mobility management on the IoT terminal according to the mobility type of the IoT terminal, that is, the mobile network sets a corresponding network connection policy for the IoT terminal according to the mobility type of the IoT terminal. For example, the IoT terminal whose mobility type is the stationary type does not need to perform a position switching operation, and a paging mechanism in a non-idle state does not need to consider a position change. For another example, because the IoT terminal whose mobility type is the first mobile type has slow mobility, a protocol requirement exists in aspects such as paging and switching. The IoT terminal whose mobility type is the second mobile type necessarily has the protocol requirement in the aspects such as paging and switching. This application does not limit specific content of the mobility management policy provided by the mobile network either.

For the IoT terminal with the first mobile type, network connectivity may be optimized according to the characteristic of the ambient IoT. For example, for an IoT terminal deployed indoors, a measurement frequency of a neighboring cell may be reduced, and the mobile network mainly performs measurement and switching decision management on a possibly accessed serving cell or neighboring cell, to save energy. For another example, a delay threshold for switching may be relaxed, so that storage time of data during switching may be prolonged, and the data is forwarded to the IoT terminal when the IoT terminal is activated again, thereby adapting to requirements of the ambient IoT on low complexity and a weak processing capability.

In some embodiments, for the IoT terminal with the second mobile type, network connectivity may not need to be optimized. For example, for an IoT terminal deployed outdoors, a measurement frequency of a neighboring cell may be maintained unchanged, or a delay threshold for switching may be maintained unchanged.

A manner in which the mobile network recognizes the mobility type of the IoT terminal may be actively receiving, for example, the IoT terminal or another entity reports the mobility type of the IoT terminal to the mobile network; may be obtained through recognition based on the obtained device information of the IoT terminal; or may be obtained through determining through big data statistics learning of an application service side or configuration information of an operator. This application does not limit the manner of recognizing the mobility type of the terminal either.

In another embodiment, the management performed by the mobile network on the IoT terminal further includes management on a status of the IoT terminal. For example, the status of the IoT terminal may include at least one of the following multiple substates, or is obtained by combining at least one of the multiple substates described below.

A deactivated substate is configured for describing that the IoT terminal is deactivated by the mobile network. Deactivation of the IoT terminal caused by the mobile network may be temporary deactivation or permanent deactivation. An IoT terminal in a permanent deactivated substate does not need to be activated again. An IoT terminal in a temporary deactivated substate may be activated again based on a specific condition. This is not limited in this embodiment.

A power-off and energy harvesting substate is configured for describing that the IoT terminal performs energy harvesting in a power-off state. The IoT terminal may periodically or quasi-periodically switch to the substate, and may perform energy storage if the IoT terminal has the energy storage capability.

A power-off but non-energy harvesting substate is configured for describing that the IoT terminal does not perform energy harvesting in a power-off state.

An activated and energy harvesting substate is configured for describing that the IoT terminal continuously performs energy harvesting in an activated state. During data transmission, the IoT terminal may perform periodic data transmission, correspondingly disable a TX/an RX, and perform energy harvesting. If the IoT terminal has the energy storage capability, the IoT terminal may perform energy storage. If the IoT terminal does not have the energy storage capability, the IoT terminal may perform energy harvesting and energy using at the same time.

An activated but non-energy harvesting substate is configured for describing that the IoT terminal does not perform energy harvesting in an activated state. During data transmission, the IoT terminal may perform periodic data transmission and intermittently disable a TX/an RX. Because energy is sufficient, energy harvesting is not performed.

In some embodiments, if the status of the IoT terminal includes the deactivated substate, the power-off and energy harvesting substate, or the power-off but non-energy harvesting substate, the core network element does not perform the access management and/or the mobility management on the IoT terminal.

In some embodiments, if the status of the IoT terminal includes the activated and energy harvesting substate or the activated but non-energy harvesting substate, the core network element allows the IoT terminal to perform periodic data transmission.

The power-off and energy harvesting substate and the power-off but non-energy harvesting substate may be combined to obtain a state, for example, a power-off state, which may be referred to as another state. When the IoT terminal is in the state, the mobile network may not focus on relevant information about energy harvesting performed by the IoT terminal. Similarly, the activated and energy harvesting substate and the activated but non-energy harvesting substate may also be combined to obtain a state, for example, an activated state, which may also be referred to as another state. When the IoT terminal is in the state, the IoT terminal may perform periodic data transmission, may disable the TX/RX, and may determine whether to perform energy harvesting according to an energy storage condition.

The combinations between the substates are merely used as exemplary descriptions for ease of understanding of the management on the status of IoT terminal provided in this application, and does not indicate a limitation. This application allows that another substate or another substate combination manner may occur in the management performed by the mobile network on the status of the IoT terminal. In addition, names of the foregoing substates may be other names, and this application is not limited thereto.

In addition, content of the management performed by the mobile network on the IoT terminal based on the status or the substate of the IoT terminal may include the access management and/or the mobility management.

Based on the foregoing content, in the IoT terminal management solution provided in this application, the IoT terminal may be the IoT terminal in the ambient IoT. Therefore, according to this application, enhancement of a characteristic of the mobile network for the ambient IoT is implemented, which includes type recognition performed by the mobile network on the IoT termina. In addition, enhancement of the access management and/or the mobility management of the mobile network according to a terminal type, a capability, a supported service layer data characteristic is implemented, to satisfy connection reachability of the ambient IoT. In addition, the IoT terminal management solution provided in this application further implements protocol support for a new terminal in the ambient IoT, to satisfy more service requirements of the ambient IoT more efficiently, especially in a case that a capability is limited.

Based on the foregoing IoT terminal management solution, an embodiment of this application further correspondingly provides an IoT terminal management method. FIG. 2 is a flowchart of an IoT terminal management method according to an exemplary embodiment of this application. The method is applied to a core network element of a mobile network. The core network element may be an access and mobility management function (AMF) or another network element. This is not limited in this application.

As shown in FIG. 2, in an exemplary embodiment, the IoT terminal management method includes S210 and S220, which are described in detail as follows:

S210: Obtain device information of an IoT terminal.

The core network element of the mobile network obtains the device information of the IoT terminal, to perform management on the IoT terminal according to the obtained device information.

A manner in which the core network element obtains the device information of the IoT terminal may be a direct obtaining manner, or may be an indirect obtaining manner. In the direct obtaining manner, the IoT terminal or another entity having the device information of the IoT terminal actively transmits the device information of the IoT terminal to the core network element. Therefore, the core network element correspondingly receives the device information transmitted by the IoT terminal or the another entity. In the indirect obtaining manner, after recognizing a communication connection to the IoT terminal, the core network element obtains, based on identifier information obtained by recognizing the IoT terminal, the device information of the IoT terminal from a specific entity. The specific entity and the another entity may be the same device, or may be different devices. This is not limited in this embodiment.

In some embodiments, based on a security authentication mechanism between a party that obtains the device information of the IoT terminal and a party of which the device information of the IoT terminal is obtained, the core network element further performs security authentication interaction between the party of which the device information of the IoT terminal is obtained and the core network element. Only after security authentication passes, the core network element obtains the device information of the IoT terminal based on the party of which the device information of the IoT terminal is obtained. The party of which the device information of the IoT terminal is obtained in this embodiment may be the IoT terminal, or may be the another entity having the device information of the IoT terminal. This is not limited in this embodiment either.

For exemplary content of the device information of the IoT terminal, reference is made to the foregoing descriptions. Details are not described in this embodiment.

S220: Perform management on the IoT terminal according to the device information of the IoT terminal, the management including at least one of access management or mobility management.

After obtaining the device information of the IoT terminal, the core network element may perform the management on the IoT terminal according to the device information of the IoT terminal. For example, the management includes the access management and/or the mobility management. For detailed content of the device information of the IoT terminal, reference is made to the foregoing descriptions, and details are not described in this embodiment.

For example, when the device information of the IoT terminal includes position information and/or application scenario information, the core network element may determine a relevant characteristic of the IoT terminal according to the position information and/or the application scenario, to provide corresponding management on the IoT terminal according to the relevant characteristic of the IoT terminal.

When the device information of the IoT terminal includes a communication connection type of the IoT terminal, the core network element may provide management on the IoT terminal according to relevant characteristics of the IoT terminal under different communication connection types.

When the device information of the IoT terminal includes an energy characteristic of the IoT terminal, the core network element may provide corresponding management on the IoT terminal according to the energy characteristic of the IoT terminal.

For content in which the core network element may provide the management on the IoT terminal, reference is made to the foregoing descriptions. Details are not described in this embodiment. In the method provided in this embodiment, the core network element can learn of relevant characteristics of the IoT terminal according to the obtained device information of the IoT terminal, and provide a matched management solution for the IoT terminal based on the relevant characteristics. When the IoT terminal is an IoT terminal in ambient IoT, an ambient IoT technology can be supported in a mobile communication network.

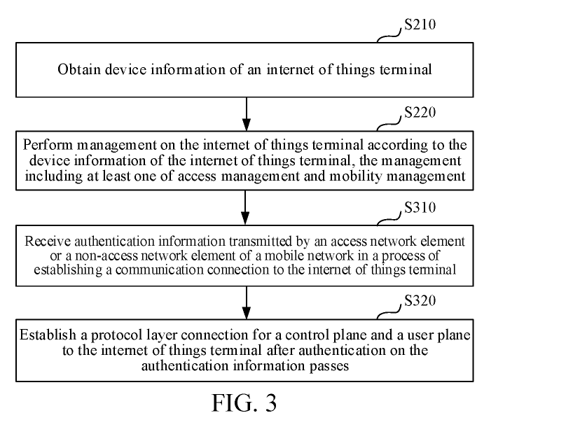

In another exemplary embodiment, as shown in FIG. 3, the IoT terminal management method further includes S310 and S320, which are described in detail as follows:

S310: Receive authentication information transmitted by an access network element or a non-access network element of the mobile network in a process of establishing the communication connection to the IoT terminal.

As described above, the access management on the IoT terminal includes two parts: wireless side access management and core network side access management. The wireless side access management is to directly establish a connection between the IoT terminal and the access network element (for example, a base station) or the non-access network element (for example, a relay device) of the mobile network. The core network side access management is responsible for cooperating with a wireless side to complete end-to-end access, including performing authentication in a wireless side connection process and establishing connections to various protocol layers. Therefore, the core network element may receive the authentication information transmitted by the access network element or the non-access network element of the mobile network in the process of establishing the communication connection to the IoT terminal.

S320: Establish a protocol layer connection for a control plane and a user plane to the IoT terminal after authentication on the authentication information passes.

After the authentication on the authentication information passes, the core network element establishes the protocol layer connection for the control plane and the user plane to the IoT terminal, for example, the foregoing protocol similar to an AS layer or a NAS layer. Therefore, the solution provided in this embodiment may further provide access management on the IoT terminal in the ambient IoT, to enhance support of the mobile communication network for the ambient IoT technology.

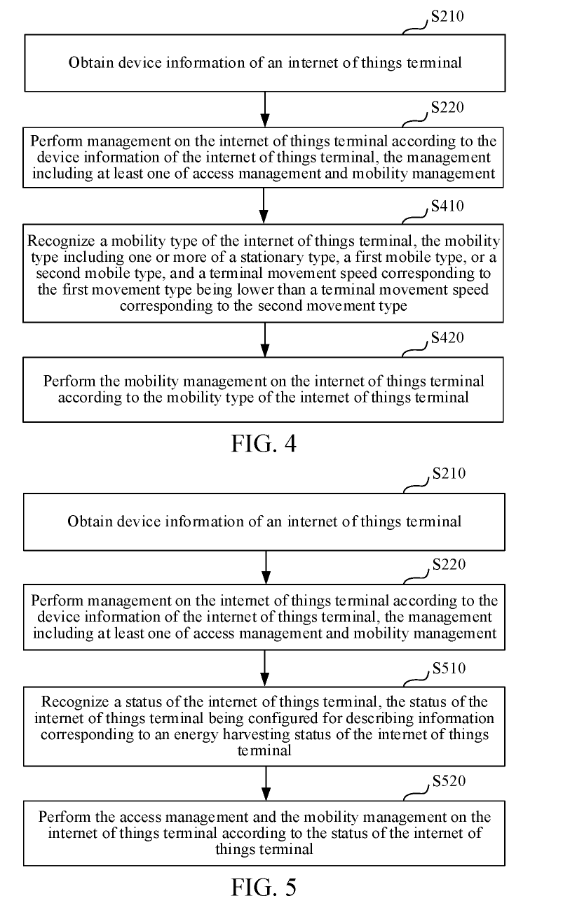

In another exemplary embodiment, as shown in FIG. 4, the IoT terminal management method further includes S410 and S420, which are described in detail as follows:

S410: Recognize a mobility type of the IoT terminal, the mobility type including one or more of a stationary type, a first mobile type, or a second mobile type, and a terminal movement speed corresponding to the first mobile type being lower than a terminal movement speed corresponding to the second mobile type.

The mobility type of the IoT terminal may be recognized by the core network element according to the foregoing obtained device information of the IoT terminal, for example, determined according to the position information and/or the application scenario information, the mobility type may be actively reported by the IoT terminal or the another entity, or the mobility type may be determined based on big data statistics learning on an application service side or configuration information of an operator. A specific manner in which the core network element recognizes the mobility type of the IoT terminal is not limited herein.

S420: Perform the mobility management on the IoT terminal according to the mobility type of the IoT terminal.

The mobility management performed by the core network element on the IoT terminal based on the recognized mobility type of the IoT terminal may include: The IoT terminal with the stationary type does not need to perform a position switching operation, and a paging mechanism in a non-idle state does not need to consider a position change either. Because the IoT terminal with the first mobile type has slow mobility, a protocol requirement exists in aspects such as paging and switching. The IoT terminal with the second mobile type necessarily has the protocol requirement in the aspects such as paging and switching. Content of the mobility management performed by the core network element on the IoT terminal described in this embodiment is merely used as an example, and does not indicate a limitation on specific content of the mobility management.

Therefore, in the solution provided in this embodiment, the mobility type of the IoT terminal in the ambient IoT is recognized, to further enhance support of the mobile communication network for the ambient IoT technology based on the recognized mobility type of the terminal.

In another exemplary embodiment, as shown in FIG. 5, the IoT terminal management method further includes S510 and S520, which are described in detail as follows:

S510: Recognize a status of the IoT terminal, the status of the IoT terminal being configured for describing information corresponding to an energy harvesting state of the IoT terminal.

In the solution of this embodiment, status information related to an energy status of the IoT terminal is introduced to perform the mobility management on the IoT terminal. The status of the IoT terminal is usually agreed in advance. For example, as described above, the status of the IoT terminal may include at least one of the following multiple substates, or may be obtained by combining at least one of the following multiple substates: a deactivated substate, a power-off and energy harvesting substate, a power-off but non-energy harvesting substate, an activated and energy harvesting substate, and an activated but non-energy harvesting substate.

For state content represented by each substate, reference is made to the foregoing descriptions, and details are not described in this embodiment again. The foregoing substates are also merely exemplary, and do not indicate a limitation on the substates of the IoT terminal. In an actual application scenario, the foregoing substates may be combined to obtain the status of the IoT terminal, or the foregoing substates may be directly used as the status of the IoT terminal. This is not limited in this embodiment either.

S520: Perform the access management and/or the mobility management on the IoT terminal according to the status of the IoT terminal.

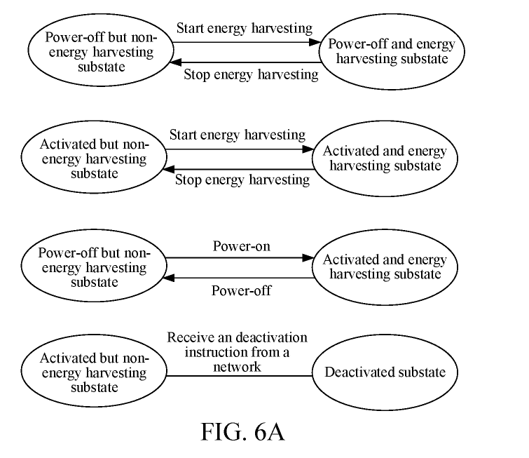

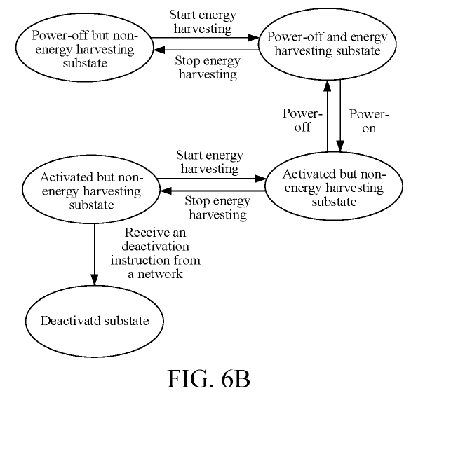

In a process of performing the access management and/or the mobility management on the IoT terminal, the IoT terminal performs relevant transition. As shown in FIGS. 6A and 6B, status transition of the IoT terminal is described by using an exemplary state machine. A relevant trigger condition is needed for the state machine to transition between different substates of the IoT terminal. For example, a <power-off but non-energy harvesting substate> is triggered and transitioned to a <power-off and energy harvesting substate> by using an energy harvesting start condition, the <power-off and energy harvesting substate> is triggered and transitioned to the <power-off but non-energy harvesting substate> by using an energy harvesting stop condition, an <activated but non-energy harvesting substate> is triggered and transitioned to an <activated and energy harvesting substate> by using the energy harvesting start condition, the <activated and energy harvesting substate> is triggered and transitioned to the <activated but non-energy harvesting substate> by using the energy harvesting stop condition, the <power-off but non-energy harvesting substate> is triggered and transitioned to the <activated and energy harvesting substate> by using a powered-on condition, and the <activated and energy harvesting substate> is correspondingly triggered and transitioned to the <power-off but non-energy harvesting substate> by using a power-off condition. If the core network element transmits a deactivation instruction to the IoT terminal, the IoT terminal transitions to an <deactivated substate> according to the received deactivation instruction.

Condition information configured for triggering mutual transition of the substates shown in FIGS. 6A and 6B is also exemplary, and FIGS. 6A and 6B do not indicate a limitation on the condition information.

For example, after the state transition of the IoT terminal occurs, for example, whether to perform energy harvesting in the power-off state is completed by the IoT terminal, and the core network element may also correspondingly record the status transition of the IoT terminal.

In the solution provided in this embodiment, support of the mobile communication network for the ambient IoT technology can be further enhanced by introducing a new status management mechanism.

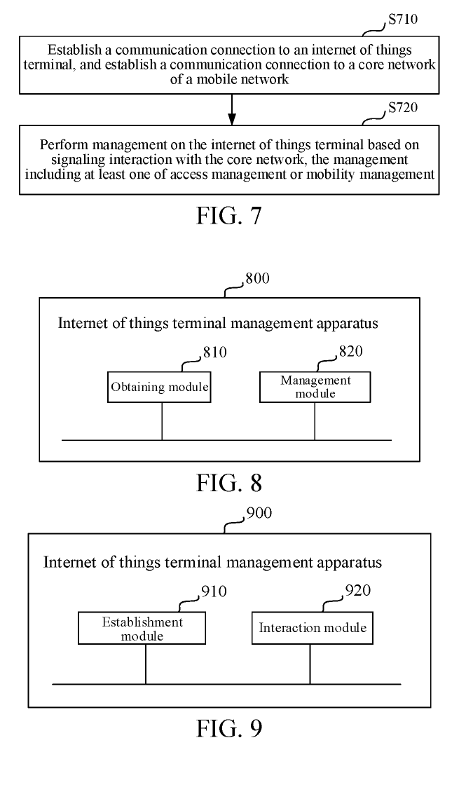

Based on the foregoing provided IoT terminal management solutions, an embodiment of this application further provides another IoT terminal management method shown in FIG. 7. The method is applied to an access network element or a non-access network element of a mobile network. The access network element may be a base station, and the non-access network element may be a relay device or another device. This is not limited in this application.

As shown in FIG. 7, in an exemplary embodiment, the IoT terminal management method includes S710 and S720, which are described in detail as follows:

S710: Establish a communication connection to an IoT terminal, and establish a communication connection to a core network of the mobile network.

The access network element or the non-access network element of the mobile network needs to establish the communication connection to the IoT terminal and establish the communication connection to the core network of the mobile network, to establish and obtain an information transmission link between the IoT terminal and the core network.

For example, a manner in which the access network element or the non-access network element establishes the communication connection to the IoT terminal may include: The IoT terminal initiates a communication connection request, and the access network element or the non-access network element correspondingly establishes the communication connection to the IoT terminal in response to the communication connection request.

The communication connection request initiated by the IoT terminal may carry usage information of the IoT terminal for the target network resource. The target network resource may be a dedicated network resource, for example, a wireless resource that is reserved by the access network element or the non-access network element for the IoT terminal and that can be used without competition, or may be a shared network resource, so that the access network element or the non-access network element establishes the communication connection to the IoT terminal on a communication frequency band corresponding to the target network resource. If the shared network resource is used, the access network element or the non-access network element may alternatively reserve a specific random access codeword resource for the IoT terminal, or increase a random access response window of the IoT terminal, to satisfy a characteristic of dense deployment of the IoT terminal.

The manner in which the access network element or the non-access network element establishes the communication connection to the IoT terminal may further include: The access network element or the non-access network element transmits a wake-up instruction to an IoT terminal covered by a network signal, to establish a communication connection to a woken-up IoT terminal.

For example, the access network element or the non-access network element may transmit the wake-up instruction in a manner like broadcast, unicast, or multicast. To facilitate management on different IoT terminals, the IoT terminals may also be grouped into different groups according to an application scenario or another criterion. After group information obtained by performing group division on multiple IoT terminals covered by the network signal is obtained, the wake-up instruction is transmitted according to the group information by using a group as a wake-up unit, to avoid affecting all IoT terminals when different IoT terminals are woken up. In addition, when group division is performed on the IoT terminals, a wake-up order may be further set for each IoT terminal in the same group, to obtain a wake-up information sequence. The access network element or the non-access network element sequentially transmits, based on the wake-up information sequence included in the group information, the wake-up instruction to the IoT terminals in the corresponding group, to implement sequential wake-up of the multiple IoT terminals.

S720: Perform management on the IoT terminal based on signaling interaction with the core network, the management including at least one of access management or mobility management.

Based on the foregoing established information transmission link between the IoT terminal and the core network, the access network element or the non-access network element performs the management on the IoT terminal based on the signaling interaction with the core network.

When device information of the IoT terminal is actively reported by the IoT terminal to a core network element, the access network element or the non-access network element further receives the device information of the IoT terminal, and then transmits the received device information of the IoT terminal to the core network element, so that the core network element performs corresponding management on the IoT terminal based on the received device information of the IoT terminal.

Based on the foregoing established information transmission link between the IoT terminal and the core network element, the access network element or the non-access network element may participate in a process of transmitting any information that needs to be transmitted on the information transmission link. This is not limited to the foregoing information. Therefore, when the IoT terminal includes an IoT terminal in ambient IoT, the method provided in this embodiment can implement support for an ambient IoT technology from a wireless side of the mobile network.

FIG. 8 is a block diagram of an IoT terminal management apparatus according to an exemplary embodiment of this application. The apparatus is applied to a core network element of a mobile network.

As shown in FIG. 8, an exemplary IoT terminal management apparatus 800 includes:

an obtaining module 810, configured to obtain device information of an IoT terminal; and

a management module 820, configured to perform management on the IoT terminal according to the device information of the IoT terminal, the management including at least one of access management or mobility management.

In another exemplary embodiment, the IoT terminal management apparatus 800 further includes a first recognition module, configured to:

recognize a mobility type of the IoT terminal, the mobility type including one or more of a stationary type, a first mobile type, or a second mobile type, and a terminal movement speed corresponding to the first mobile type being lower than a terminal movement speed corresponding to the second mobile type; and

perform the mobility management on the IoT terminal according to the mobility type of the IoT terminal.

In another exemplary embodiment, the first recognition module is configured to recognize the mobility type of the IoT terminal according to the device information of the IoT terminal.

In another exemplary embodiment, the first recognition module is configured to skip performing a position switching operation on the IoT terminal if the mobility type of the IoT terminal is the stationary type.

In another exemplary embodiment, the first recognition module is configured to reduce a measurement frequency of a neighboring cell for the IoT terminal if the mobility type of the IoT terminal is the first mobile type.

In another exemplary embodiment, the first recognition module is configured to relax a delay threshold for cell switching performed by the IoT terminal if the mobility type of the IoT terminal is the first mobile type.

In another exemplary embodiment, the first recognition module is configured to maintain a measurement frequency of a neighboring cell unchanged for the IoT terminal if the mobility type of the IoT terminal is the second mobile type.

In another exemplary embodiment, the first recognition module is configured to maintain a delay threshold for cell switching performed by the IoT terminal unchanged if the mobility type of the IoT terminal is the second mobile type.

In another exemplary embodiment, the IoT terminal management apparatus 800 further includes a second recognition module, configured to:

recognize a status of the IoT terminal, the status of the IoT terminal being configured for describing information corresponding to an energy harvesting state of the IoT terminal; and

perform the access management and/or the mobility management on the IoT terminal according to the status of the IoT terminal.

In another exemplary embodiment, the second recognition module is further configured to:

transmit a deactivation instruction to the IoT terminal.

In another exemplary embodiment, the status of the IoT terminal includes at least one of the following multiple substates, or is obtained by combining at least one of the following multiple substates:

a deactivated substates;

a power-off and energy harvesting substate;

a power-off but non-energy harvesting substate;

an activated and energy harvesting substate; and

an activated but non-energy harvesting substate.

In another exemplary embodiment, the IoT terminal management apparatus 800 further includes a deactivation module, configured to transmit a deactivation instruction to the IoT terminal, the deactivation instruction being configured for triggering the IoT terminal to transition to the deactivated substate.

In another exemplary embodiment, the first recognition module is configured to skip performing the access management and/or the mobility management on the IoT terminal if the status of the IoT terminal includes the deactivated substate, the power-off and energy harvesting substate, or the power-off but non-energy harvesting substate.

In another exemplary embodiment, the first recognition module is configured to allow the IoT terminal to perform periodic data transmission if the status of the IoT terminal includes the activated and energy harvesting substate or the activated but non-energy harvesting substate.

In another exemplary embodiment, the IoT terminal management apparatus 800 further includes a connection module, configured to:

receive authentication information transmitted by an access network element or a non-access network element of the mobile network in a process of establishing a communication connection to the IoT terminal; and

establish a protocol layer connection for a control plane and a user plane to the IoT terminal after authentication on the authentication information passes.

In another exemplary embodiment, the obtaining module 810 is further configured to receive the device information of the IoT terminal transmitted by the IoT terminal or another entity, the another entity having the device information of the IoT terminal.

In another exemplary embodiment, the obtaining module 810 is further configured to: after recognizing the communication connection to the IoT terminal, obtain, based on a device identifier of the IoT terminal, the device information of the IoT terminal from a specific entity.

In another exemplary embodiment, the IoT terminal management apparatus 800 further includes an authentication module, configured to perform security authentication interaction between a party of which the device information of the IoT terminal is obtained and the core network element, and obtain, through the obtaining module 810, the device information of the IoT terminal after the security authentication passes.

In another exemplary embodiment, the device information includes one or more of position information, application scenario information, and type information.

In another exemplary embodiment, the type information includes one or more of an energy characteristic and a communication connection type of the IoT terminal.

In another exemplary embodiment, the energy characteristic of the IoT terminal includes one or more of an energy storage characteristic, an energy harvesting capability, and an energy consumption rate.

In the foregoing IoT terminal management apparatus 800, the IoT terminal may be an IoT terminal in ambient IoT. Therefore, support of the mobile network for an ambient IoT technology is implemented based on a core network side of the mobile network.

FIG. 9 is a block diagram of an IoT terminal management apparatus according to still another exemplary embodiment of this application. The apparatus is applied to an access network element or a non-access network element of a mobile network. The access network element may be a base station, and the non-access network element may be a relay device or another device.

As shown in FIG. 9, an exemplary IoT terminal management apparatus 900 includes:

an establishment module 910, configured to establish a communication connection to an IoT terminal, and establish a communication connection to a core network of the mobile network; and

an interaction module 920, configured to perform management on the IoT terminal based on signaling interaction with the core network, the management including at least one of access management or mobility management.

In another exemplary embodiment, the establishment module 910 is further configured to:

receive a communication connection request transmitted by the IoT terminal, the communication connection request carrying usage information for a target network resource; and

establish, in response to the communication connection request, the communication connection to the IoT terminal on a communication frequency band corresponding to the target network resource.

In another exemplary embodiment, the target network resource includes a dedicated network resource or a shared network resource.

In another exemplary embodiment, the establishment module 910 is further configured to:

reserve, when the communication connection request includes usage information for the shared network resource, a specific random access codeword resource for the IoT terminal, or increase a random access response window of the IoT terminal.

In another exemplary embodiment, the establishment module 910 is further configured to transmit a wake-up instruction to an IoT terminal covered by a network signal; and establish a communication connection to a woken-up IoT terminal.

In another exemplary embodiment, the establishment module 910 is further configured to obtain group information obtained by performing group division on multiple IoT terminals covered by the network signal; and transmit, according to the group information corresponding to the IoT terminals, the wake-up instruction by using a group as a wake-up unit.

In another exemplary embodiment, the establishment module 910 is further configured to sequentially transmit, based on a wake-up information sequence included in the group information, the wake-up instruction to the IoT terminals in the corresponding group.

In the foregoing IoT terminal management apparatus 900, the IoT terminal may be an IoT terminal in ambient IoT. Therefore, support of the mobile network for an ambient IoT technology is implemented based on a wireless side of the mobile network.

The IoT terminal management apparatus provided in the foregoing embodiments is based on the same concept as the IoT terminal management method provided in the foregoing embodiments. Specific manners of performing operations by each module and each unit are described in detail in the method embodiments, and details are not described herein again. In an actual application of the IoT terminal management apparatus provided in the foregoing embodiments, the foregoing functions may be allocated to different function modules according to requirements, that is, an internal structure of the apparatus is divided into different functional modules to complete all or some of the foregoing functions. This is not limited herein.

An embodiment of this application further provides an IoT terminal management device, including: one or more processors; and a memory, configured to have one or more programs stored herein, the one or more programs, when executed by the one or more processors, causing the IoT terminal management device to implement the IoT terminal management method provided in the foregoing embodiments.

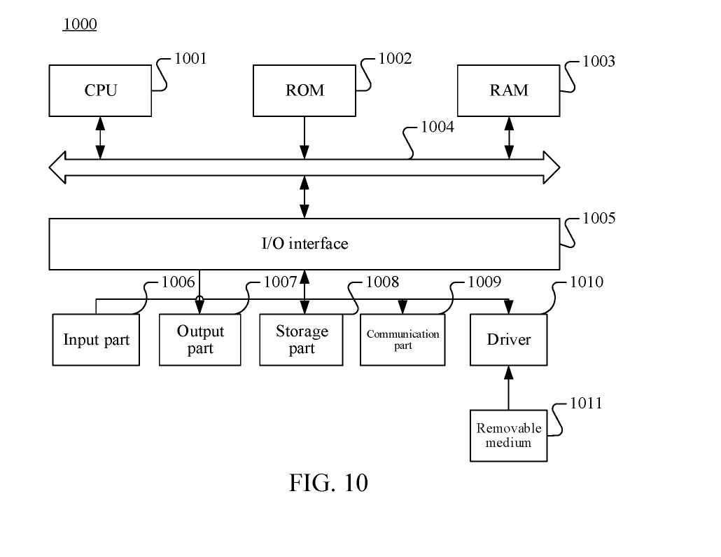

FIG. 10 is a schematic structural diagram of a computer system suitable for implementing an IoT terminal management device according to an embodiment of this application. A computer system 1000 of the IoT terminal management device shown in FIG. 10 is merely an example, and is not to bring any limitation to a function and use scope of the embodiments of this application.

As shown in FIG. 10, the computer system 1000 includes a central processing unit (CPU) 1001, which may perform various appropriate actions and processing according to a program stored in a read-only memory (ROM) 1002 or a program loaded from a storage part 1008 to a random access memory (RAM) 1003, for example, performing the method provided in the foregoing embodiments. The RAM 1003 further has various programs and data required by system operations stored therein. The CPU 1001, the ROM 1002, and the RAM 1003 are connected to each other through a bus 1004. An input/output (I/O) interface 1005 is also connected to the bus 1004.

The following components are connected to the I/O interface 1005: an input part 1006 including a keyboard, a mouse, and the like; an output part 1007, including a cathode ray tube (CRT), a liquid crystal display (LCD), and a speaker; a storage part 1008 including a hard disk and the like; and a communication part 1009 including a network interface card like a local area network (LAN) card or a modem. The communication part 1009 performs communication processing over a network like the Internet. A driver 1010 is also connected to the I/O interface 1005 as required. A removable medium 1011, for example, a magnetic disk, an optical disc, a magneto-optical disc, or a semiconductor memory, is installed on the drive 1010 as required, so that a computer program read from the removable medium 1011 is installed into the storage part 1008 as required.

Particularly, according to an embodiment of this application, the foregoing processes referring to the flowcharts may be implemented as a computer software program. For example, an embodiment of this application includes a computer program product, including a computer program carried in a computer-readable medium. The computer program includes a computer program configured for performing the methods shown in the flowcharts. In such an embodiment, the computer program may be downloaded and installed from a network and/or installed from the removable medium 1011 by using the communication part 1009. When the computer program is executed by the CPU 1001, various functions limited in the system of this application are performed.

The computer-readable medium shown in this embodiment of this application may be a computer-readable signal medium or a computer-readable storage medium, or any combination thereof. More specific examples of the computer-readable storage medium may include but are not limited to: an electrical connection having one or more wires, a portable computer disk, the hard disk, the random access memory (RAM), the read-only memory (ROM), an erasable programmable read only memory (EPROM), a flash memory, an optical fiber, a compact disc read-only memory (CD-ROM), an optical storage device, a magnetic storage device, or any suitable combination of the foregoing computer-readable storage mediums. The computer program included in the computer-readable medium may be transmitted by using any suitable medium, which includes, but is not limited to, a wireless medium, a wired medium, or the like, or any suitable combination thereof.

The flowcharts and block diagrams in the accompanying drawings show system architectures, functions, and operations that may be implemented by the system, the method, and the computer program product according to the embodiments of this application. Each block in a flowchart or a block diagram may represent a module, a program segment, or a part of code, and the foregoing module, program segment, or part of code includes one or more executable instructions configured for implementing a specified logical function. In addition, in some implementations used as substitutes, a function annotated in a block may alternatively occur in a sequence different from a sequence annotated in an accompanying drawing. For example, actually two blocks shown in succession may be performed basically in parallel, or sometimes the two blocks may be performed in a reverse sequence, which is determined according to a related function. Each block in a block diagram or a flowchart, or a combination of blocks in a block diagram or a flowchart may be implemented by using a dedicated hardware-based system performing a specified function or operation, or may be implemented by using a combination of dedicated hardware and computer instructions.

A related unit described in the embodiments of this application may be implemented in a software manner, or may be implemented in a hardware manner, or the described unit may be disposed in a processor. Names of these units do not constitute a limitation on the units.

Another aspect of this application further provides a computer-readable storage medium, having a computer program stored therein, the computer program, when executed by a processor, implementing the foregoing IoT terminal management method. The computer-readable storage medium may be included in the IoT terminal management device described in the foregoing embodiments, or may exist alone and is not assembled into the IoT terminal management device.

Another aspect of this application further provides a computer program product or a computer program, including computer instructions, the computer instructions being stored in a computer-readable storage medium. A processor of a computer device reads the computer instructions from the computer-readable storage medium, and the processor executes the computer instructions, to cause the computer device to perform the IoT terminal management method provided in the foregoing embodiments.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing descriptions are merely some exemplary embodiments of this application, and are not intended to limit the embodiments of this application. A person of ordinary skill in the art may make corresponding modifications and variations conveniently according to the main concept and the spirit of this application. Therefore, the protection scope of this application is to be subject to the scope of the claims.

In one implementation of this application, relevant data such as device information of an IoT device in ambient IoT is related. When the foregoing embodiments of this application are applied to a specific product or technology, user permission or consent needs to be obtained, and collection, use, and processing of the relevant data need to comply with relevant laws, regulations, and standards of relevant countries and regions.

What is claimed is:

1. A management method, applied to a core network element of a mobile network, the method comprising:
obtaining device information of an Internet of Things (IoT) terminal; and
performing management on the IoT terminal according to the device information, the management including at least one of access management or mobility management.

2. The method according to claim 1, further comprising:
recognizing a mobility type of the IoT terminal, the mobility type including one or more of a stationary type, a first mobile type, or a second mobile type, and a terminal movement speed corresponding to the first mobile type being lower than a terminal movement speed corresponding to the second mobile type; and
performing the mobility management on the IoT terminal according to the mobility type.

3. The method according to claim 2, wherein recognizing the mobility type includes:
recognizing the mobility type according to the device information.

4. The method according to claim 2, wherein performing the mobility management includes at least one of:
skipping performing a position switching operation on the IoT terminal in response to the mobility type being the stationary type;
reducing a measurement frequency of a neighboring cell for the IoT terminal in response to the mobility type being the first mobile type;
relaxing a delay threshold for cell switching performed by the IoT terminal in response to the mobility type being the first mobile type;
maintaining the measurement frequency of the neighboring cell unchanged for the IoT terminal in response to the mobility type being the second mobile type; or
maintaining the delay threshold for cell switching performed by the IoT terminal unchanged in response to the mobility type being the second mobile type.

5. The method according to claim 1, further comprising:
recognizing a status of the IoT terminal, the status being configured for describing information corresponding to an energy harvesting state of the IoT terminal; and
performing the at least one of the access management or the mobility management on the IoT terminal according to the status of the IoT terminal.

6. The method according to claim 5, wherein the status of the IoT terminal includes at least one of following substates, or is obtained by combining two or more of the following substates:
a deactivated substate, configured for describing that the IoT terminal is deactivated by the mobile network;
a power-off and energy harvesting substate;
a power-off but non-energy harvesting substate;
an activated and energy harvesting substate; and
an activated but non-energy harvesting substate.

7. The method according to claim 6, further comprising:
transmitting a deactivation instruction to the IoT terminal, the deactivation instruction being configured for triggering the IoT terminal to transition to the deactivated substate.

8. The method according to claim 6, wherein performing the at least one of the access management or the mobility management on the IoT terminal according to the status of the IoT terminal includes at least one of:
skipping performing the at least one of the access management or the mobility management on the IoT terminal in response to the status of the IoT terminal including the deactivated substate, the power-off and energy harvesting substate, or the power-off but non-energy harvesting substate; or
allowing the IoT terminal to perform periodic data transmission in response to the status of the IoT terminal including the activated and energy harvesting substate or the activated but non-energy harvesting substate.

9. The method according to claim 1, further comprising:
receiving authentication information transmitted by an access network element or a non-access network element of the mobile network in a process of establishing a communication connection to the IoT terminal; and
establishing a protocol layer connection for a control plane and a user plane to the IoT terminal after authentication on the authentication information passes.

10. The method according to claim 1, wherein obtaining the device information includes at least one of:
receiving the device information of the IoT terminal transmitted by the IoT terminal or another entity that has the device information of the IoT terminal; or
after recognizing a communication connection to the IoT terminal, obtaining, based on a device identifier of the IoT terminal, the device information of the IoT terminal from a specific entity.

11. The method according to claim 1, wherein the device information includes one or more of position information, application scenario information, and type information.

12. The method according to claim 1, wherein the type information includes one or more of an energy characteristic and a communication connection type of the IoT terminal.

13. The method according to claim 12, wherein the energy characteristic includes one or more of an energy storage characteristic, an energy harvesting capability, and an energy consumption rate.

14. A non-transitory computer-readable storage medium storing computer-readable instructions that, when executed by a processor of a computer, causing the computer to perform the method according to claim 1.

15. A management device comprising:
one or more processors; and
a memory storing one or more programs that, when executed by the one or more processors, cause the management device to:
obtain device information of an Internet of Things (IoT) terminal; and
perform management on the IoT terminal according to the device information, the management including at least one of access management or mobility management.

16. A management method, applied to an access network element or a non-access network element of a mobile network, the method comprising:
establishing a communication connection to an IoT terminal, and establishing a communication connection to a core network of the mobile network; and
performing management on the IoT terminal based on signaling interaction with the core network, the management including at least one of access management or mobility management.

17. The method according to claim 16, wherein establishing the communication connection to the IoT terminal includes:
receiving a communication connection request transmitted by the IoT terminal, the communication connection request carrying usage information for a target network resource; and
establishing, in response to the communication connection request, the communication connection to the IoT terminal on a communication frequency band corresponding to the target network resource.

18. The method according to claim 16, wherein establishing a communication connection to an IoT terminal includes:
transmitting a wake-up instruction to one or more IoT terminals covered by a network signal; and
establishing a communication connection to one of the one or more IoT terminals that has been woken up.

19. A management device comprising:
one or more processors; and
a memory storing one or more programs that, when executed by the one or more processors, cause the management device to perform the method according to claim 16.

20. A non-transitory computer-readable storage medium storing computer-readable instructions that, when executed by a processor of a computer, causing the computer to perform the method according to claim 16.
